(19) United States
(12) Patent Application Publication
(10) Pub. No.: US 2026/0095478 A1
(43) Pub. Date: Apr. 2, 2026

(54) Apparatus and Method for Predicting Malicious Domains

(71) Applicant: HEIMDAL SECURITY A/S, København (Copenhagen) (DK)

(72) Inventors: Valentin Rusu, Bucharest (RO); Eugeniu Cernei, Bucharest (RO)

(73) Assignee: HEIMDAL SECURITY A/S, København (Copenhagen) (DK)

(21) Appl. No.: 19/352,516

(22) Filed: Oct. 8, 2025

Related U.S. Application Data
(63) Continuation-in-part of application No. 18/333,620, filed on Jun. 13, 2023, now abandoned.

(30) Foreign Application Priority Data
Jun. 15, 2022 (EP) 22179244.3

(51) Int. Cl. H04L 9/40

(52) U.S. Cl. CPC H04L 63/1433

(57) ABSTRACT

A probability of a domain being malicious is calculated based on an input data set for processing in a computer system. The method comprises dataset extraction, including extraction of network data and claimable data. The method further comprises data preprocessing including transforming the network data from sparse to dense and transforming the Domain Word data into vectorial representations. The method also includes processing the data through a trained classifier to determine the probability of a domain being malicious.

### FIELD OF THE INVENTION

The invention relates to the area of internet security and more specifically to the area of detecting malicious domains and taking precautions against such malicious domains.

### BACKGROUND OF THE INVENTION

Security on the internet and precautions against malicious domains is a growing concern to users of the internet. Where the problem for a long time was primarily connected to the unsystematic interruption of random activities, the problem has become increasingly serious as the systematic approach to this is undertaken by criminals and consequences are often severe and may cause business interruption for longer periods and hence cause severe financial losses.

For that reason, there has also been a focus on developing technology that may predict/identify malicious domains and there are a number of these disclosed in the patent literature.

In US 2021/0377303 a method is disclosed, aiming at determining the likelihood of a domain being malicious. The method uses several components, including a trained machine learning model to predict the likelihood.

In US 2021/0360013 a method is disclosed, where a malicious domain is detected through obtaining network connection data of an electronic device and capturing log data related to at least one domain name from the network connection data.

Even though these previously known methods provide some remedy to the problem there is still a need for improvement of the technology as the accuracy and efficiency of the known methods still leave room for improvement.

For that reason, the present invention provides improvement in the accuracy and efficiency of the technology in respect of identifying the malicious domains.

### SUMMARY OF THE INVENTION

According to embodiments of the invention this is achieved through a method for calculating the probability of a domain being malicious based on an input data set for processing in a computer system, the method comprising:
Dataset extraction, comprising extracting two types of input data:
   Network data, selected from WHOIS, DNS, Reverse PTR, Domain Ranking and popularity data, Domain Authority; and
   Domain Word data;
Data preprocessing, including transforming network data from sparse to dense through feature averaging, picking the most common options, finding correlating features, or choosing a default value for unfilled data, depending on the feature type;
Data preprocessing, including transforming claimable data into vectorial representations (embeddings), such as through a trained natural language processing network, also referred to as an Embedding Network;
Temporarily storing (caching) claimable and network data in databases; and
Data processing of the preprocessed data through a trained tree-based network, also referred to as a Domain Risk Classifier, to determine the probability of a domain being malicious.

In a preferred embodiment, the Embedding Network is a trained neural network.

As the terms are used herein, network data means data extracted from authoritative services (e.g., Whois, DNS, reverse PTR), and claimable data means data extracted from the actual domain name, thus Domain Word data.

Through such a method according to the invention, the efficiency and accuracy of the process of identifying malicious domains can be significantly increased, and hence provide for a safer online environment for the user of the method.

Advantageously, the data preprocessing method for representing claimable data (words) as vectorial representations is trained unsupervised, using a model to predict a target context based on a nearby word.

The preprocessing may further comprise:
Data preprocessing to represent claimable data (words) as vectorial representations (embeddings) using n-grams; and
Data preprocessing for filling missing data.

In some embodiments, the data processing algorithm uses a tree-based classifier, such as a decision tree or a gradient-boosted decision-tree ensemble.

In some embodiments, the data processing algorithm uses similarity scores, gains and thresholds for determining a probability.

In some embodiments, the classifier, also referred to as the Domain Risk Classifier, uses a probability distribution to determine a risk factor.

In some embodiments, the method further comprises a probability system for determining the risk score of a domain.

In some embodiments, a probability distribution system for cybersecurity to perform the method is implemented.

In some embodiments, a method for reading data in batches for optimizing the resources used by a system is implemented in connection with the method according to the invention.

In some embodiments, a method for minimizing the memory consumption by splitting the data reading and processing in CPU, RAM, Cache and HD memory is implemented in connection with the method according to the invention.

In some embodiments, a method for parallel learning and inference based on splitting the data in quantiles is implemented.

In some embodiments, the method further comprises training the Embeddings Network using a hierarchical classifier implemented as a binary tree on which each leaf node represents a Domain word (an n-gram) generated with the Huffman tree algorithm. By using a hierarchical classifier implemented as a binary tree and constructed by executing a Huffman coding algorithm, the computational complexity may be reduced because more frequent n-grams will be closer to the root of the tree, thereby providing a shorter computational path for the more frequent n-grams. So, in the context of the Embedding Network, the word “classifier” or “classification” is not referring to classifying the risk of the domain being malicious, but rather to computing the conditional probability of a specific context word by multiplying node probabilities along its path using the hierarchical structure.

Embodiments of the invention may further comprise one or more of the following features:
A machine learning pipeline adapted to generate random trees and calculates each tree's gain and similarity score based on a threshold; calculating an output value and adjusting the weights based on the error rate (loss function), and through a second-order Taylor, approximation between the error rate (loss function), gradient (first derivative of the loss function) and hessian (second derivative of the loss function), calculating the needed adjustment for improving the accuracy based on a test dataset;
A method adapted to convert odds to probabilities;
A method adapted to use logistic functions for determining a probability score;
A method adapted to use a minimizing negative likelihood function to calculate an error rate (loss function);
A tree-based trained network, such as the Domain Risk Classifier, adapted to combine sparse data from domains and word vectorial representations called embeddings;
A method adapted to use a domain corpus;
A method adapted for classifying DNS attacks like typo squatting, phishing, and C&Cs using trained networks;
A method adapted to use character-level n-grams for domain embeddings extraction;
A method adapted to use cosine similarity for measuring the distance between domain embedding vectors;
A method adapted to combine unsupervised and supervised trained networks.
A method adapted to combine a tree-boost network, such as the Domain Risk Classifier, with a natural language processing network, such as the Embedding Network;
A network, such as the Embedding Network, adapted to use hidden layers for n-grams for embeddings extraction.
A network, such as the Embedding Network, adapted to use subwords for correlation between words;
A network, such as the Embedding Network, adapted to sum the probabilities of words and subword embeddings;
A method adapted to determine context words from a center word;
A method adapted for generating n-grams starting from a word;
A method adapted for training an unsupervised learning network, such as the Embedding network, on a supervised task that is ignored in the prediction step (at inference);
A method adapted to use second-order derivative of the chain rule for reduction to canonical form;
A method adapted for adjusting the vectorial representations of words to determine their correlation based on a corpus;
A method adapted for generating random vectorial representations of words starting from a corpus;
A method adapted for extracting Whois domain sparse data from authoritative services;
A method adapted for extracting DNS domain sparse data from authoritative services;
A method adapted for reverse IP lookup; and
A method adapted for extracting HTML code statistics.

### BRIEF DESCRIPTION OF THE DRAWINGS

Other embodiments of the invention will become apparent by reference to the detailed description in conjunction with the figures, wherein elements are not to scale so as to show the details more clearly, wherein like reference numbers indicate like elements throughout the several views, and wherein:

FIG. 1 shows a data sample according to an embodiment of the invention;

FIG. 2 shows data sample probabilities according to an embodiment of the invention;

FIG. 3 shows data sample probabilities according to an embodiment of the invention;

FIG. 4 shows data sample probabilities according to an embodiment of the invention;

FIG. 5 shows data sample probabilities according to an embodiment of the invention;

FIG. 6 shows data sample probabilities according to an embodiment of the invention;

FIG. 7 shows data sample probabilities according to an embodiment of the invention;

FIGS. 8A and 8B show data sample probabilities according to an embodiment of the invention;

FIG. 9 shows data sample probabilities according to an embodiment of the invention;

FIG. 10 shows data sample probabilities according to an embodiment of the invention;

FIG. 11 shows data sample probabilities according to an embodiment of the invention;

FIG. 12 shows data sample probabilities according to an embodiment of the invention;

FIG. 13 shows data sample probabilities according to an embodiment of the invention;

FIG. 14 shows data sample probabilities according to an embodiment of the invention;

FIG. 15 shows data sample probabilities according to an embodiment of the invention;

FIG. 16 shows data sample probabilities according to an embodiment of the invention;

FIG. 17 shows data sample loss functions according to an embodiment of the invention;

FIG. 18 shows data sample loss functions according to an embodiment of the invention;

FIG. 19 shows a data sample loss function according to an embodiment of the invention;

FIG. 20 shows a data sample loss function according to an embodiment of the invention;

FIG. 21 shows data sample probabilities according to an embodiment of the invention;

FIG. 22 shows nine ways to calculate the quantiles according to an embodiment of the invention;

FIG. 23 shows data sample probabilities according to an embodiment of the invention;

FIG. 24 shows data sample probabilities according to an embodiment of the invention;

FIG. 25 shows an example of word processing according to an embodiment of the invention;

FIG. 26 shows an example of word processing according to an embodiment of the invention;

FIG. 27 shows an example of word processing according to an embodiment of the invention;

FIG. 28 shows an example of word processing according to an embodiment of the invention;

FIG. 29 shows an example of a domain classification process flow according to an embodiment of the invention; and

FIG. 30 shows an example of a binary Huffman tree according to an embodiment of the invention.

### DETAILED DESCRIPTION

In a preferred embodiment, the system for detecting the malicious domain comprises two trained networks, such as the Embedding Network and the Domain Risk Classifier.

The Domain Risk Classifier was developed as a gradient-boosting classification tree and trained on more than thirty DNS features, i.e. the transformed network data (Whois, DNS, etc.), and six million embeddings of domains. The Domain Risk Classifier was designed to work with very large and complicated datasets, as described hereinafter. For simplicity, the gradient boosting algorithm will be explained using only one dimension, one feature, and four data samples.

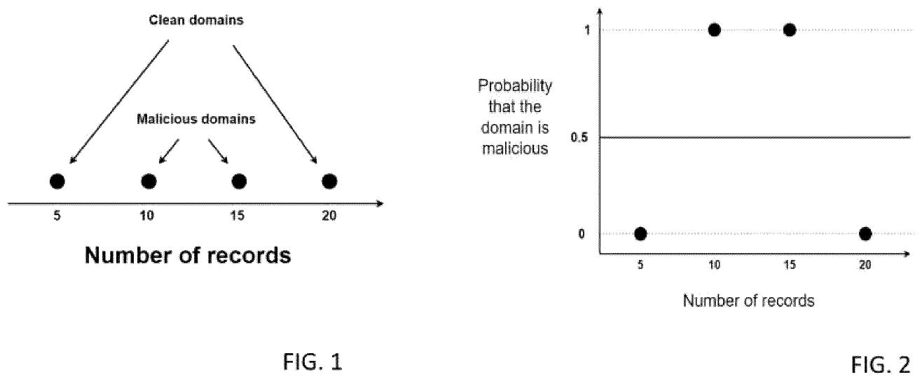

For the data sample from FIG. 1, the algorithm will make a default prediction of 0.5 since there is a 50% chance that a domain is malicious or not. Since the ground truth is known for the data samples (two malicious domains and two clean domains), their probability of being malicious is 0 or 1, as described in FIG. 2.

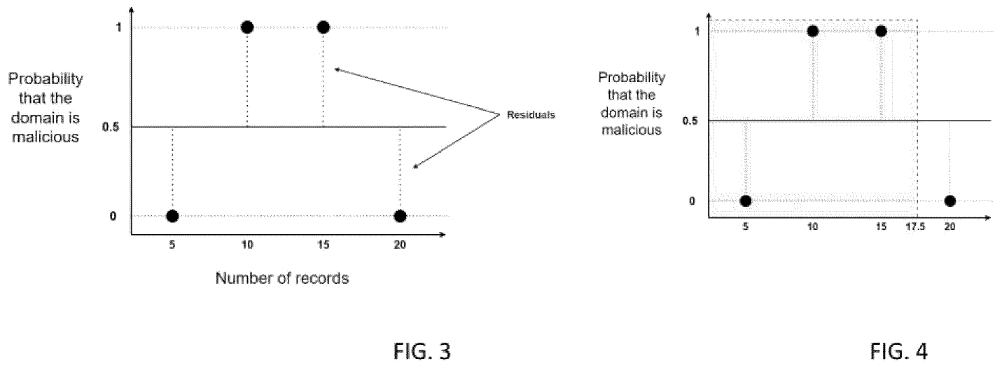

Since the initial prediction is 0.5 and the classes for samples are 0 or 1, the difference between ground truth and prediction is called Residual (the differences between Observed and Predicted values), as depicted in FIG. 3. It is a method for measuring the error and the quality of the prediction.

In order to build the trees, the algorithm starts as a single leaf by putting the Residual into the node. For each leaf, it calculates a Quality Score, named Similarity Score for the Residuals.

$$Similarity Score = \frac{{( \sum {Residuals}_{i} )}^{2}}{\sum [ Previous {Probability}_{i} \times ( 1 - Previous {Probability}_{i} ) ] + λ}$$

where λ (lambda) is a Regularization parameter.

For Residuals=−0.5, 0.5, 0.5, −0.5 and λ=0:

$$Similarity Score = \frac{{( - 0.5 + 0.5 + 0.5 - 0.5 )}^{2}}{\sum [ Previous {Probability}_{i} \times ( 1 - Previous {Probability}_{i} ) ] + 0}$$

$$Similarity Score = \frac{0}{\sum [ Previous {Probability}_{i} \times ( 1 - Previous {Probability}_{i} ) ] + 0}$$

$$Similarity Score = 0$$

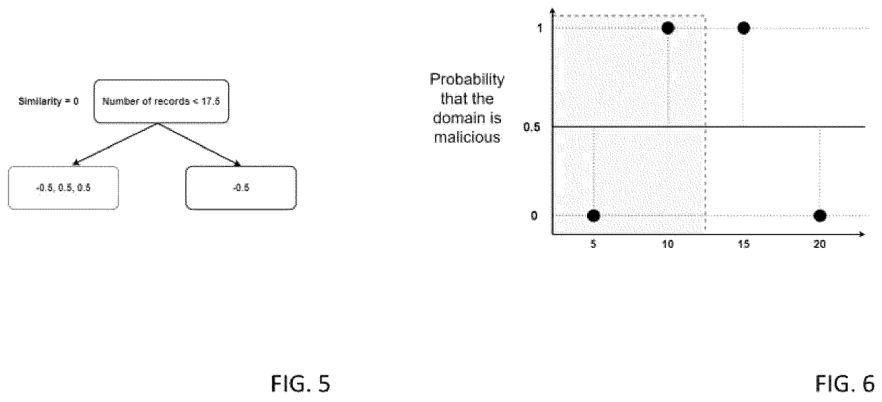

The similarity score for the first leaf is 0. As shown in FIG. 4, the algorithm can now split the Residuals into multiple groups to search for better results. As shown in FIG. 5, a threshold of 17.5 (the mean value between the values of the domains 20 and 15) will split the Residuals into two leaves.

$$Previous Probability = Prediction from the initial leaf = 0.5$$

$$Similarity Score Left Node = \frac{{( - 0.5 + 0.5 + 0.5 )}^{2}}{[ 0.5 \times ( 1 - 0.5 ) ] + [ 0.5 \times ( 1 - 0.5 ) ] + [ 0.5 \times ( 1 - 0.5 ) ] + 0}$$

$$Similarity Score Left Node = 0.33$$

$$Similarity Score Right Node = \frac{{( - 0.5 )}^{2}}{[ 0.5 \times ( 1 - 0.5 ) ] + 0}$$

$$Similarity Score Right Node = 1$$

At this point, the algorithm needs a metric to quantify if the leaves cluster similar Residuals better than the root. The property is called Gain, and it aggregates the Similarity Scores.

$$Gain = {Left}_{similarity} + {Right}_{similarity} - {Root}_{similarity}$$

$$Gain = 0.33 + 1 - 0 = 1.33$$

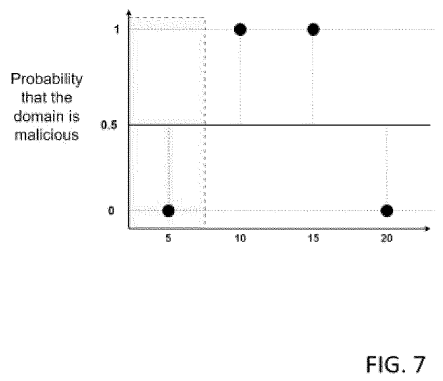

As shown in FIGS. 6 and 7, the algorithm needs to calculate the gain value for each threshold (17.5, 12.5, 7.5) and keep the one with the more significant value as the root node.

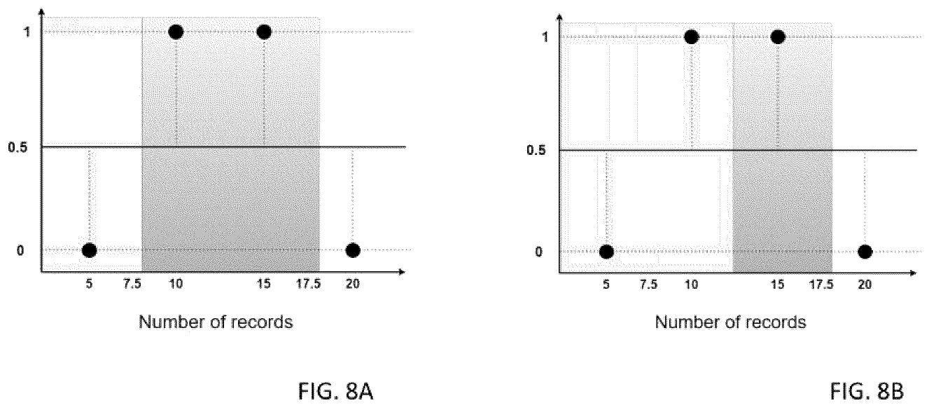

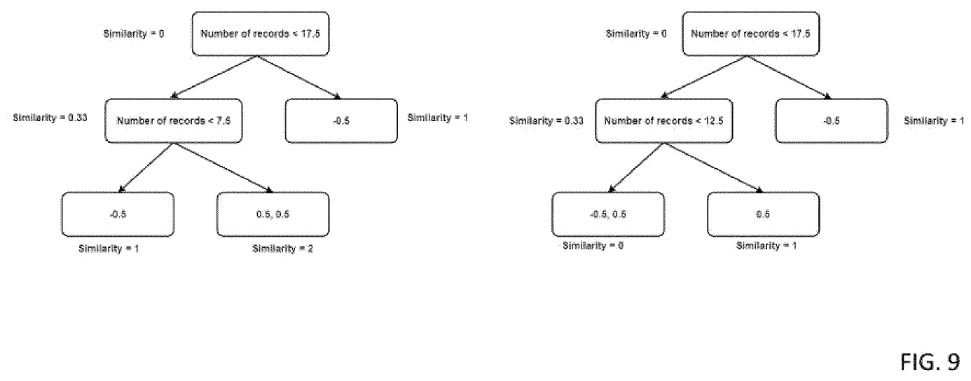

The largest Gain value can be achieved with a threshold of 17.5, which makes it the starting node. After deciding on the starting node, the same algorithm should be applied for the remaining nodes. See FIGS. 8A, 8B, and 9.

The threshold lower than 7.5 has a better gain value and will be selected as the best candidate for the 2nd level node. The algorithm continues like that for the defined depth, which is six by default. The tree depth is a hyperparameter that will be optimized during training period.

Once the tree is done, there is a Prune method for dimensionality reduction. The algorithm Prunes the tree based on its Gain values. The terminology for Prune value is gamma (γ). The algorithm will calculate the difference between the Gain of the lowest branch and Prune value. If the difference is negative, the branch will be removed. For γ=3, all the branches will be removed, and all that would be left is the original prediction since the Gain for the second branch is 2.66, and the Gain for the first branch is 1.33. For γ=2, the tree will remain the same since the second branch is 2.66.

$$Gain - γ = \{ \begin{matrix}> 0 , & do not prune \\ < 0 , & prune\end{matrix}$$

Based on the below formula, lambda is a regularization parameter that reduces de similarity scores and the gain value implicitly. For λ=1, the Gain values for the first and second branches will be 0.34 and 0.72, while for λ=0, they are 1.33 and 2.66. This implies that values of λ greater than 0 will reduce the sensitivity of the tree to individual observations by pruning and combining them with other observations.

$$Similarity Score = \frac{{( \sum {Residuals}_{i} )}^{2}}{\sum [ Previous {Probability}_{i} \times ( 1 - Previous {Probability}_{i} ) ] + λ}$$

The output of a leaf node can be calculated using the following formula

$$Output value = \frac{( \sum {Residuals}_{i} )}{\sum [ Previous {Probability}_{i} \times ( 1 - Previous {Probability}_{i} ) ] + λ}$$

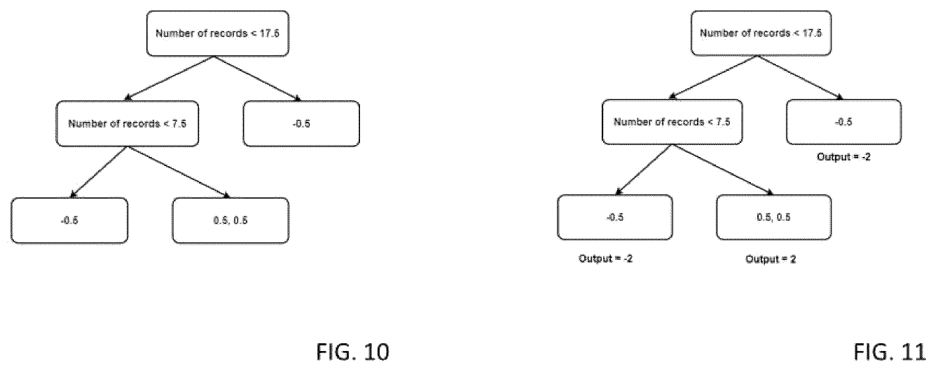

### See FIG. 10.

For λ=0,

$$Output value = \frac{( - 0.5 )}{[ 0.5 \times ( 1 - 0.5 ) ] + 0} = - 2$$

For λ=1,

$$Output value = \frac{( - 0.5 )}{[ 0.5 \times ( 1 - 0.5 ) ] + 1} = - 0.4$$

When λ>0, it reduces the amount that a single observation adds to the new prediction. Thus, it reduces the prediction's sensitivity to isolated observations. See FIG. 11.

At this point, the first tree is ready. Based on that information, the algorithm can make a new Prediction. In order to build a new prediction, the algorithm should start from the initial prediction. Since the Predictions are in terms of the log(odds) and the leaf is derived from Probability, the results cannot be added together without a transformation.

$$( \frac{p}{1 - p} ) = odds$$

$$log ( \frac{p}{1 - p} ) = log ( odds )$$

$$For p = 0. 5 , log ( \frac{0.5}{1 - 0.5} ) = log ( odds )$$

$$0 = log ( odds )$$

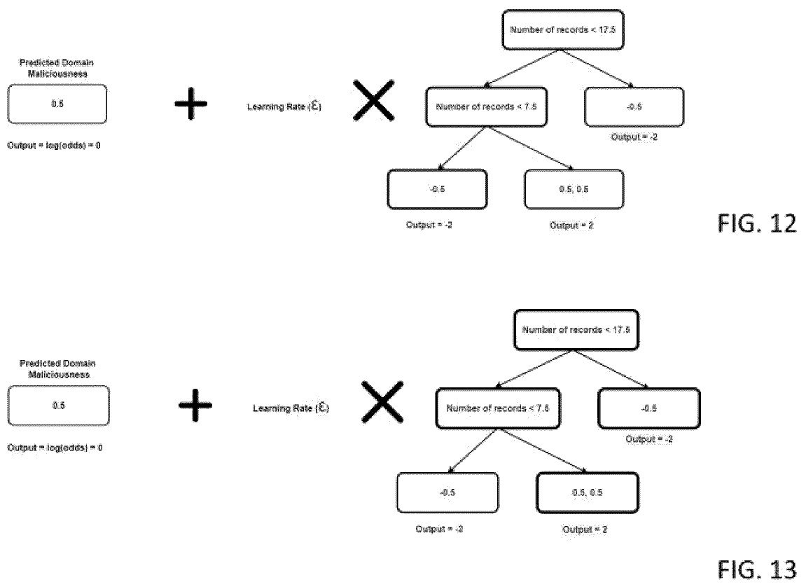

### See FIG. 12.

$$log ( odds ) Prediction = log ( odds ) Original Prediction + ε \times Tree Output Value$$

In order to determine the prediction value, the algorithm should calculate the sum of the original prediction with the output value scaled by the Learning Rate (the default value is 0.3). If the learning rate would not scale the output, their sum will end up as the original prediction. Thus, a learning rate is used to scale the contribution from the new tree, and its value is between 0 and 1. If the learning rate would not be used, the algorithm will end up with low Bias (the simplifying assumptions made by the model to make the target function easier to approximate) but very high Variance (the amount that the estimate of the target function will change given different training data).

$$log ( odds ) Prediction = 0 + 0.3 \times ( - 2 ) = - 0.6$$

To convert a log(odds) value into a probability, it needs to be plugged into a Logistic Function:

$$Probability = \frac{{e}^{log ( odds )}}{1 + {e}^{log ( odds )}}$$

$$Probability = \frac{{e}^{- 0.6}}{1 + {e}^{- 0.6}} = 0.35$$

### See FIG. 13.

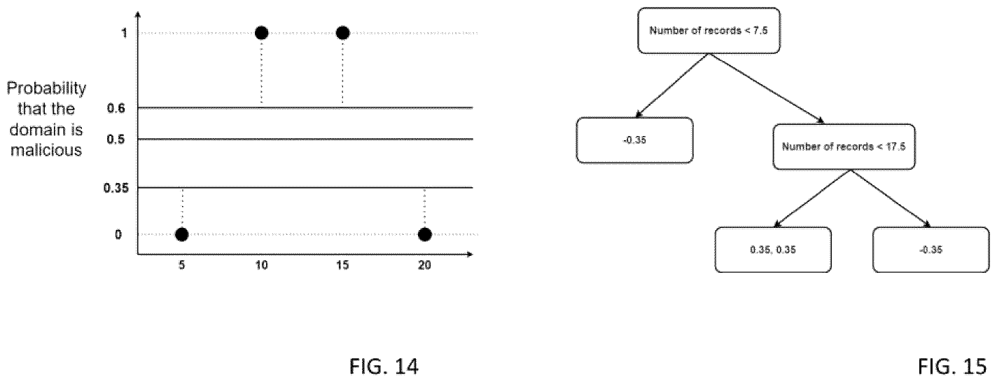

The algorithm should calculate the predicted output for each data sample based on its residual value. See FIG. 14.

The residuals are smaller than before, which means that the algorithm made a small step in the right direction. With new residuals, the algorithm can build new trees that will better fit the data. See FIG. 15

In the second tree, calculating the Similarity Score is different, considering that Previous Probabilities are no longer the same for all the observations (same for Output Value).

$$Similarity Score = \frac{{( \sum {Residuals}_{i} )}^{2}}{\sum [ Previous {Probability}_{i} \times ( 1 - Previous {Probability}_{i} ) ] + λ}$$

$$Similarity Score = \frac{{( \sum {Residuals}_{i} )}^{2}}{\begin{matrix}[ ( 0.35 ) \times ( 1 - 0.35 ) ] + [ ( 0.65 ) \times ( 1 - 0.65 ) ] + [ ( 0.65 ) \times \\ ( 1 - 0.65 ) ] + [ ( 0.35 ) \times ( 1 - 0.35 ) ] + λ\end{matrix}}$$

After building another tree, the algorithm will make new predictions that will return smaller residuals and build new trees. It will keep building trees until the residuals are small enough or reach the maximum number of trees.

### Mathematical Implementation

The Loss Function used in the classification process is the negative log-likelihood.

$$L ( {y}_{i} , {p}_{i} ) = - [ {y}_{i} log ( {p}_{i} ) + ( 1 - {y}_{i} ) log ( 1 - {p}_{i} ) ]$$

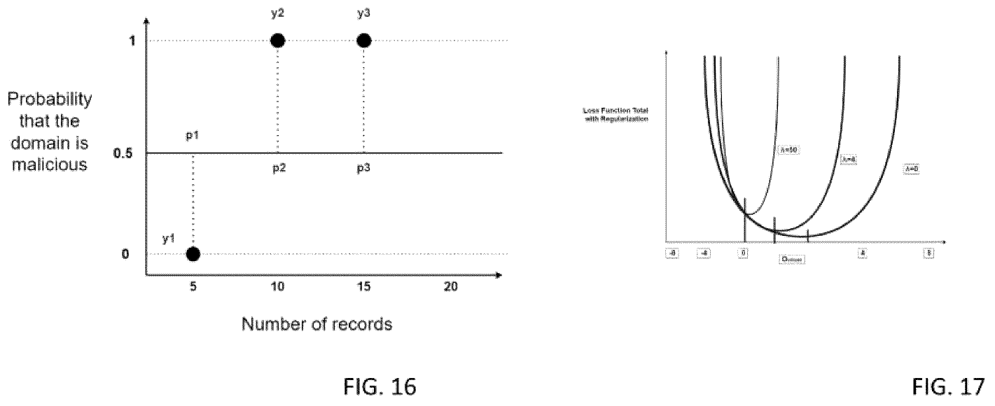

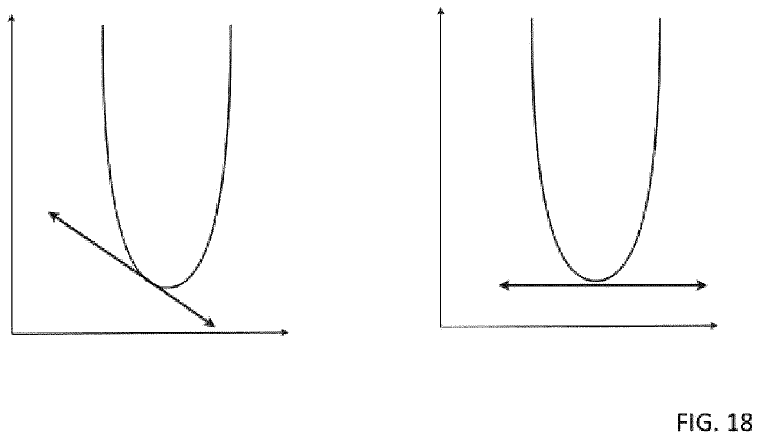

### See FIG. 16.

The algorithm uses the loss function to build trees by minimizing the following equation.

$$[ {\sum }_{i = 1}^{n} L ( {y}_{i} , {p}_{i} ) ] + γ T + \frac{1}{2} λ {O}_{value}^{2}$$

T is the number of terminal nodes or leaves in a tree, and λ (gamma) is a user-defined penalty. It will not be used in future mathematic calculus since it is used in pruning, which takes place after the whole tree is built. For this reason, it plays no role in deriving the Optimal Output Values or Similarity Scores.

$$[ {\sum }_{i = 1}^{n} L ( {y}_{i} , {p}_{i} ) ] + \frac{1}{2} λ {O}_{value}^{2}$$

$$Loss Function + Regularization Term$$

The goal is to find an Output Value (Oᵥₐₗᵤₑ) for the leaf that minimizes the whole equation.

If different values are used for the output of the leaves for different residuals and different regularization values, the result will be as shown in the following graph. When the Regularization is 0, then the optimal Oᵥₐₗᵤₑ is at the bottom of the blue parabola, where the derivative is 0. If the λ (lambda) is increased, the lowest point in the parabola shifts closer to 0. See FIG. 17.

To explain the math behind the loss function, it would be easier to remove the Regularization by setting λ (lambda) to 0.

The algorithm uses the Second Order Taylor Approximation to determine the optimal Output Value.

$$[ {\sum }_{i = 1}^{n} L ( {y}_{i} , {p}_{i} ) ] + \frac{1}{2} λ {O}_{value}^{2}$$

$${p}_{i} = {p}_{i}^{0} + {O}_{value}$$

$$[ {\sum }_{i = 1}^{n} L ( {y}_{i} , {p}_{i}^{0} + {O}_{value} ) ] + \frac{1}{2} λ {O}_{value}^{2}$$

$$where ,$$

$$L ( {y}_{i} , {p}_{i}^{0} + {O}_{value} ) \approx L ( {y}_{i} , {p}_{i} ) + [ \frac{d}{{dp}_{i}} L ( {y}_{i} , {p}_{i} ) ] {O}_{value} + \frac{1}{2} [ \frac{{d}^{2}}{{dp}_{i}^{2}} L ( {y}_{i} , {p}_{i} ) ] {O}_{value}^{2}$$

and where, L(yᵢ, pᵢ) is the Loss Function for the previous prediction,

$$[ \frac{d}{{dp}_{i}} L ( {y}_{i} , {p}_{i} ) ]$$

is the first derivative of the Loss Function Gradient (g), and

$$\frac{{d}^{2}}{{dp}_{i}^{2}} L ( {y}_{i} , {p}_{i} )$$

is the second derivative of the Loss Function Hessian (h).

$$L ( {y}_{i} , {p}_{i}^{0} + {O}_{value} ) \approx L ( {y}_{i} , {p}_{i} ) + {gO}_{value} + \frac{1}{2} {hO}_{value}^{2}$$

$$[ {\sum }_{i = 1}^{n} L ( {y}_{i} , {p}_{i}^{0} + {O}_{value} ) ] + \frac{1}{2} λ {O}_{value}^{2}$$

The summation above is expanded as:

$$L ( {y}_{1} , {p}_{1}^{0} + {O}_{value} ) + L ( {y}_{2} , {p}_{2}^{0} + {O}_{value} ) + … + L ( {y}_{n} , {p}_{n}^{0} + {O}_{value} ) + \frac{1}{2} λ {O}_{value}^{2}$$

Plugging in the second order Taylor approximation for each Loss Function:

$$L ( {y}_{1} , {p}_{1}^{0} ) + {g}_{1} {O}_{value} + \frac{1}{2} {h}_{1} {O}_{value}^{2} + L ( {y}_{2} , {p}_{2}^{0} ) + {g}_{2} {O}_{value} + \frac{1}{2} {h}_{2} {O}_{value}^{2} + … + L ( {y}_{n} , {p}_{n}^{0} ) + {g}_{n} {O}_{value} + \frac{1}{2} {h}_{n} {O}_{value}^{2} + \frac{1}{2} λ {O}_{value}^{2}$$

The end objective is to find an Output Value that minimizes the Loss Function with Regularization. For this reason, the terms that do not contain the Output Value can be removed since they do not affect the optimal value. This can be reduced by eliminating the constant

$$L ( {y}_{1} , {p}_{1}^{0} )$$

to obtain the following:

$${g}_{1} {O}_{value} + \frac{1}{2} {h}_{1} {O}_{value}^{2} + {g}_{2} {O}_{value} + \frac{1}{2} {h}_{2} {O}_{value}^{2} + … + {g}_{n} {O}_{value} + \frac{1}{2} {h}_{n} {O}_{value}^{2} + \frac{1}{2} λ {O}_{value}^{2}$$

$$( {g}_{1} + {g}_{2} + … + {g}_{n )} {O}_{value} + \frac{1}{2} ( {h}_{1} + {h}_{2} + … + {h}_{n} + λ ) {O}_{value}^{2}$$

To minimize a function, the algorithm should take the derivative with respect to the output value and set the derivative equal to 0.

$$\frac{d}{{dO}_{value}} ( {g}_{1} + {g}_{2} + … + {g}_{n )} {O}_{value} + \frac{1}{2} ( {h}_{1} + {h}_{2} + … + {h}_{n} + λ ) {O}_{value}^{2} = 0$$

### See FIG. 18.

After derivation:

$$( {g}_{1} + {g}_{2} + … + {g}_{n )} + ( {h}_{1} + {h}_{2} + … + {h}_{n} + λ ) {O}_{value} = 0$$

$${O}_{value} = \frac{- ( {g}_{1} + {g}_{2} + … + {g}_{n )}}{( {h}_{1} + {h}_{2} + … + {h}_{n} + λ )}$$

For the following Classification Loss Function:

$$L ( {y}_{i} , {p}_{i} ) = - [ {y}_{i} log ( {p}_{i} ) + ( 1 - {y}_{i} ) log ( 1 - {p}_{i} ) ]$$

$$L ( {y}_{i} , {log ( odds )}_{i} ) = - {y}_{i} log ( odds ) + log ( 1 + {e}^{log ( odds )} )$$

$$\frac{d}{d log ( odds )} L ( {y}_{i} , {log ( odds )}_{i} ) = - {y}_{i} \frac{{e}^{{log ( odds )}_{i}}}{1 + {e}^{{log ( odds )}_{i}}}$$

$$\frac{{d}^{2}}{d {log ( odds )}^{2}} L ( {y}_{i} , {log ( odds )}_{i} ) = \frac{{e}^{log ( odds )} )}{1 + {e}^{log ( odds )}} x \frac{1}{1 + {e}^{log ( odds )}}$$

$$since$$

$${p}_{i} = \frac{{e}^{{log ( odds )}_{i}} )}{1 + {e}^{{log ( odds )}_{i}}} ,$$

then the algorithm can convert log(odds) back to probabilities:

$$Gradient {g}_{i} = \frac{d}{d log ( odds )} L ( {y}_{i} , {log ( odds )}_{i} ) = - {y}_{i} \frac{{e}^{{log ( odds )}_{i}} )}{1 + {e}^{{log ( odds )}_{i}}} = - ( {y}_{i} - {p}_{i} )$$

$$Hessian {h}_{i} = \frac{{d}^{2}}{d {log ( odds )}^{2}} L ( {y}_{i} , {log ( odds )}_{i} ) = \frac{{e}^{log ( odds )} )}{1 + {e}^{log ( odds )}} x \frac{1}{1 + {e}^{log ( odds )}} = {p}_{i} x ( 1 - {p}_{i} )$$

$${O}_{value} = \frac{- ( {g}_{1} + {g}_{2} + … + {g}_{n )}}{( {h}_{1} + {h}_{2} + … + {h}_{n} + λ )}$$

$${O}_{value} = \frac{- ( - ( {y}_{1} - {p}_{1} ) + - ( {y}_{2} - {p}_{2} ) + … + - ( {y}_{n} - {p}_{n} ) )}{( {p}_{1} x ( 1 - {p}_{1} ) + {p}_{2} x ( 1 - {p}_{2} ) + … + {p}_{n} x ( 1 - {p}_{n} ) + λ )}$$

$${O}_{value} = \frac{( \sum {Residual}_{i} )}{\sum [ Previous {Probability}_{i} \times ( 1 - Previous {Probability}_{i} ) ] + λ}$$

For a Regression Loss Function:

$$L ( {y}_{i} , {p}_{i} ) = \frac{1}{2} {( {y}_{i} - {p}_{i} )}^{2}$$

$${g}_{i} = \frac{d}{{dp}_{i}} \frac{1}{2} {( {y}_{i} - {p}_{i} )}^{2} = - ( {y}_{i} - {p}_{i} )$$

$${h}_{i} = \frac{{d}^{2}}{{dp}_{i}^{2}} \frac{1}{2} {( {y}_{i} - {p}_{i} )}^{2} = \frac{d}{{dp}_{i}} - ( {y}_{i} - {p}_{i} ) = 1$$

$${O}_{value} = \frac{- ( - ( {y}_{1} - {p}_{1} ) + - ( {y}_{2} - {p}_{2} ) + … + - ( {y}_{n} - {p}_{n} ) )}{( 1 + 1 + … + 1 + λ )}$$

$${O}_{value} = \frac{Sum of Residuals}{Number of Residuals + λ}$$

Now, the algorithm can calculate the Output Value for each leaf by plugging derivatives of the Loss Functions into the equation for the Output Value, but to grow the tree, the algorithm needs to derive the equations for the Similarity Score.

Remember that the algorithm derived the equation for the Oᵥₐₗᵤₑ by minimizing the sum of the Loss Functions plus the Regularization. Thus, depending on the Loss Function, optimizing it might be challenging, so it was approximated with a Second-Order Taylor Polynomial:

$$[ {\sum }_{i = 1}^{n} L ( {y}_{i} , {p}_{i}^{0} + {O}_{value} ) ] + \frac{1}{2} λ {O}_{value}^{2}$$

That being said, starting from the above equation, the algorithm ends up with the below value, as proved before.

$$( {g}_{1} + {g}_{2} + … + {g}_{n )} {O}_{value} + \frac{1}{2} ( {h}_{1} + {h}_{2} + … + {h}_{n} + λ ) {O}_{value}^{2}$$

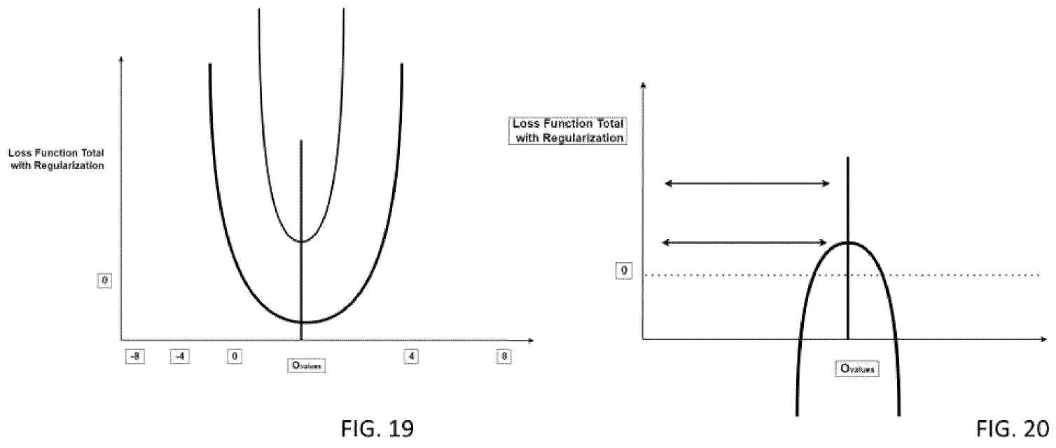

Because the constants have been removed when deriving the equation, the final equation is not equal to the starting one. However, if both equations are plotted on a graph as shown in FIG. 19, the same x-axis coordinate represented by the Oᵥₐₗᵤₑ tells the location of the lowest points in both parabolas.

$${O}_{value} = \frac{- ( {g}_{1} + {g}_{2} + … + {g}_{n )}}{( {h}_{1} + {h}_{2} + … + {h}_{n} + λ )}$$

The algorithm uses the simplified version to determine the Similarity Score. The first thing is to multiply everything by negative 1, which will flip the parabola over the horizontal line y=0, as shown in FIG. 20.

$$- 1 x [ ( {g}_{1} + {g}_{2} + … + {g}_{n )} {O}_{value} + \frac{1}{2} ( {h}_{1} + {h}_{2} + … + {h}_{n} + λ ) {O}_{value}^{2} ]$$

$$- ( {g}_{1} + {g}_{2} + … + {g}_{n )} {O}_{value} - \frac{1}{2} ( {h}_{1} + {h}_{2} + … + {h}_{n} + λ ) {O}_{value}^{2}$$

Now, the optimal Oᵥₐₗᵤₑ represents the x-axis coordinate for the highest point on the parabola, which is the Similarity Score. However, the Similarity Score used in the implementation is actually two times that number.

$$- ( {g}_{1} + {g}_{2} + … + {g}_{n} ) {O}_{value} - \frac{1}{2} ( {h}_{1} + {h}_{2} + … + {h}_{n} + λ ) {O}_{value}^{2}$$

$${O}_{value} = \frac{- ( {g}_{1} + {g}_{2} + … + {g}_{n} )}{( {h}_{1} + {h}_{2} + … + {h}_{n} + λ )}$$

$$- ( {g}_{1} + {g}_{2} + … + {g}_{n} ) \frac{- ( {g}_{1} + {g}_{2} + … + {g}_{n} )}{( {h}_{1} + {h}_{2} + ⋯ + {h}_{n} + λ )} - \frac{1}{2} {( {h}_{1} + {h}_{2} + ⋯ + {h}_{n} + λ ) [ \frac{- ( {g}_{1} + {g}_{2} + … + {g}_{n} )}{( {h}_{1} + {h}_{2} + ⋯ + {h}_{n} + λ )} ]}^{2}$$

$$\frac{{( {g}_{1} + {g}_{2} + … + {g}_{n} )}^{2}}{( {h}_{1} + {h}_{2} + ⋯ + {h}_{n} + λ )} - \frac{1}{2} ( {h}_{1} + {h}_{2} + ⋯ + {h}_{n} + λ ) \frac{{( {g}_{1} + {g}_{2} + … + {g}_{n} )}^{2}}{{( {h}_{1} + {h}_{2} + ⋯ + {h}_{n} + λ )}^{2}}$$

$$\frac{{( {g}_{1} + {g}_{2} + … + {g}_{n} )}^{2}}{( {h}_{1} + {h}_{2} + ⋯ + {h}_{n} + λ )} - \frac{1}{2} \frac{{( {g}_{1} + {g}_{2} + … + {g}_{n} )}^{2}}{( {h}_{1} + {h}_{2} + ⋯ + {h}_{n} + λ )}$$

$$Similarity Score = \frac{1}{2} \frac{{( {g}_{1} + {g}_{2} + … + {g}_{n} )}^{2}}{( {h}_{1} + {h}_{2} + ⋯ + {h}_{n} + λ )}$$

In the algorithm implementation, the ½ is omitted since the Similarity Score is a relative measure, and as long as every Similarity Score is scaled with the same amount, the results of the comparisons will be the same.

$$Similarity Score = \frac{{( {g}_{1} + {g}_{2} + … + {g}_{n} )}^{2}}{( {h}_{1} + {h}_{2} + ⋯ + {h}_{n} + λ )}$$

For the following Classification Loss Function:

$$L ( {y}_{i} , {p}_{i} ) = - [ {y}_{i} log ( {p}_{i} ) + ( 1 - {y}_{i} ) log ( 1 - {p}_{i} ) ]$$

$$Gradient {g}_{i} = \frac{d}{d log ( odds )} L ( {y}_{i} , {log ( odds )}_{i} ) = - {y}_{i} \frac{{e}^{lo {g ( odds )}_{i}} )}{1 + {e}^{lo {g ( o d d s )}_{i}}} = - ( {y}_{i} - {p}_{i} )$$

$$Hessian {h}_{i} = \frac{{d}^{2}}{d {log ( odds )}^{2}} L ( {y}_{i} , {log ( odds )}_{i} ) = \frac{{e}^{lo g ( o d d s )} )}{1 + {e}^{lo g ( o d d s )}} x \frac{1}{1 + {e}^{lo g ( o d d s )}} = {p}_{i} x ( 1 - {p}_{i} )$$

$$Similarity Score = \frac{( - ( {y}_{1} - {p}_{1} ) + - ( {y}_{2} - {p}_{2} ) + … + - ( {y}_{n} - {p}_{n} ) )}{( {p}_{1} x ( 1 - {p}_{1} ) + {p}_{2} x ( 1 - {p}_{2} ) + ⋯ + {p}_{n} x ( 1 - {p}_{n} ) + λ )}$$

$$Similarity Score = \frac{{( \sum {Residual}_{i} )}^{2}}{\sum [ Previous {Probability}_{i} \times ( 1 - Previous {Probability}_{i} ) ] + λ}$$

For a Regression Loss Function:

$$L ( {y}_{i} , {p}_{i} ) = \frac{1}{2} {( {y}_{i} - {p}_{i} )}^{2}$$

$${g}_{i} = \frac{d}{{dp}_{i}} \frac{1}{2} {( {y}_{i} - {p}_{i} )}^{2} = - ( {y}_{i} - {p}_{i} )$$

$${h}_{i} = \frac{{d}^{2}}{{dp}_{i}^{2}} \frac{1}{2} {( {y}_{i} - {p}_{i} )}^{2} = \frac{d}{{dp}_{i}} - ( {y}_{i} - {p}_{i} ) = 1$$

$$Similarity Score = \frac{{( - ( {y}_{1} - {p}_{1} ) + - ( {y}_{2} - {p}_{2} ) + … + - ( {y}_{n} - {p}_{n} ) )}^{2}}{( 1 + 1 + ⋯ + 1 + λ )}$$

$$Similarity Score = \frac{Sum of {Residuals}^{2}}{Number of Residuals + λ}$$

### Optimization

The algorithm is very efficient with extensive datasets, as will be proved in this section. The algorithm uses a Greedy Algorithm to build trees by setting up different threshold values. This works well for relatively small datasets but it is not fast enough for large amounts of data. For this reason, an Approximate Greedy Algorithm is better suited for large-scale datasets.

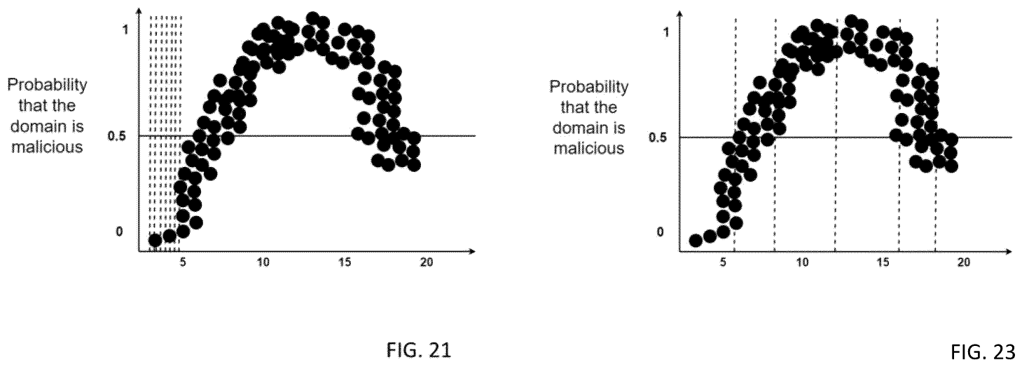

For the following dataset from the below image, a Greedy Algorithm will become slow since it will need to look at every possible threshold value. The dataset used in the following example only contains one feature. It will be very computationally expensive for a more complex dataset with more than 300 features to test every threshold. See FIG. 21.

The Approximate Greedy Algorithm uses quantiles to define different threshold levels. The easiest definition for quantile is the position where a sample is divided into equal-sized, adjacent subgroups. It can also refer to dividing a probability distribution into areas of equal probability. The median is a quantile; the median is placed in a probability distribution so that exactly half of the data is lower than the median and half of the data is above the median. The median cuts a distribution into two equal areas, and so it is sometimes called 2-quantile. Percentiles are quantiles that divide the data into 100 equally sized groups. The median will be called the 50th percentile.

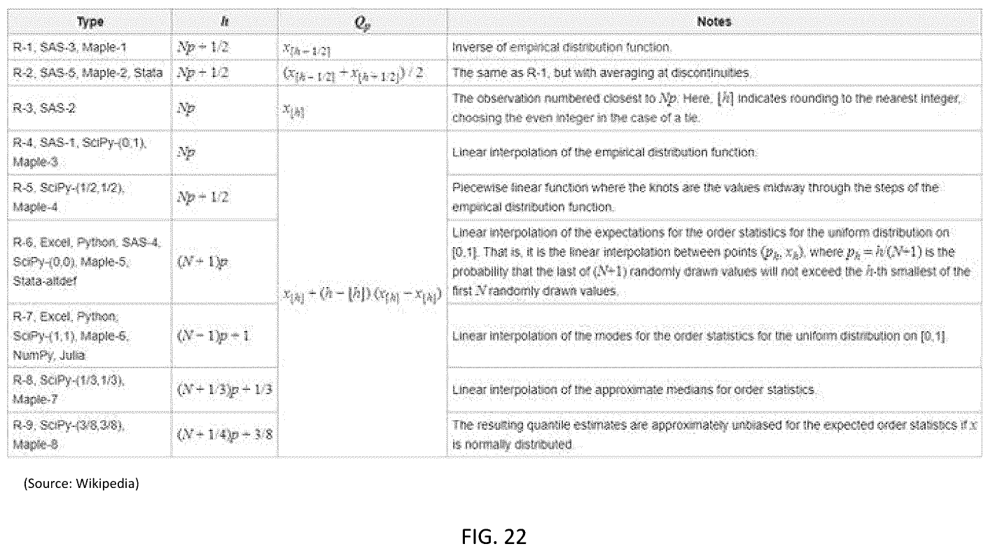

There are multiple ways to calculate the quantiles. Only R's quantile( ) function provides 9 different ways to calculate, each one resulting in slightly different results. Since it is not in the purpose of this technical review, the entire calculation details can be found in the table shown in FIG. 22.

The Approximate Greedy Algorithm in this algorithm means that instead of testing all possible thresholds, it only tests the quantiles. By default, the algorithm uses about 33 quantiles. There are about 33 quantiles and not precisely 33, because the algorithm uses Parallel Learning and Weighted Quantile Sketch, as will be explained. See FIG. 23.

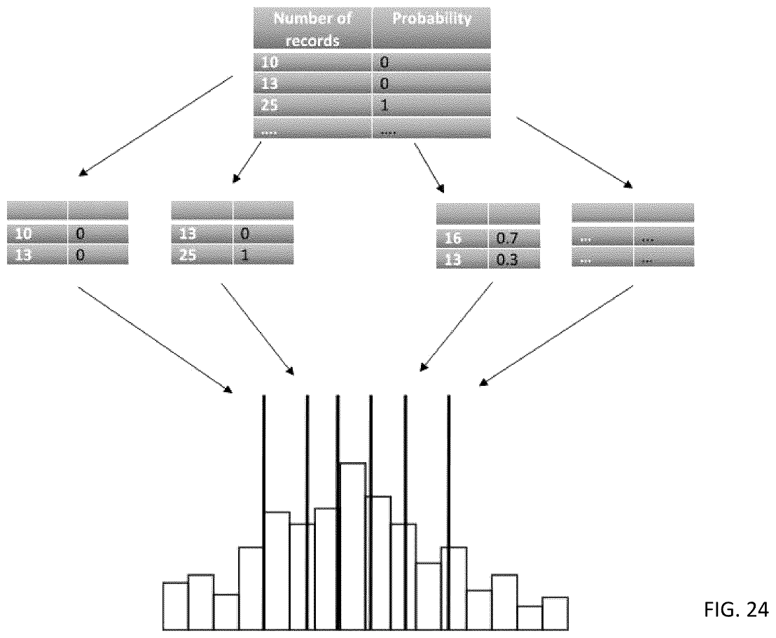

When there is a large volume of data that cannot fit into a computer's memory at one time, finding quantiles and sorting lists will become very slow. To solve this problem, a class of algorithms called Sketches can quickly create approximate solutions. It can be split into small pieces for a very large dataset that will be processed on a network. The Quantile Sketch Algorithm combines the values for each splice and creates an approximate histogram as shown in FIG. 24. Based on the histogram, the algorithm can calculate approximate quantiles used in the Approximate Greedy Algorithm.

Usually, quantiles are set up so that the same number of observations are in each one. In contrast, for Weighted Quantiles, each observation has a corresponding weight, and the sum of the Weights are the same in each quantile. The weight for each observation is the 2^{nd} derivative of the Loss Function, which is referred as Hessian. For regression the weights are all equal to 1, which means that the weighted quantiles are just like normal quantiles and contain an equal number of observations. In contrast, for Classification the weights are:

$$Weight = Previous {Probability}_{i} \times ( 1 - Previous {Probability}_{i} )$$

In practice, weights are calculated while the tree is built.

| Number of records | Weight | Probability |
|---|---|---|
| 10 | 0.21 | 0.30 |
| 13 | 0.25 | 0.55 |
| 25 | 0.16 | 0.80 |
| . . . | . . . | . . . |

Every computer has a CPU (Central Processing Unit) that has a small amount of Cache Memory. The CPU can use this memory faster than any other memory in the computer. The CPU is also attached to a large amount of Main Memory (RAM: Random Access Memory). It is described as being fast, but it is slower than cache memory. Storage is accessed via the memory/IO subsystem, not directly attached to the CPU. Storage can store more data but it is the slowest of all memory options. The goal is to maximize the processing on Cache Memory. The procedure is called Cache-Aware Access. The algorithm puts the Gradients and Hessian in the Cache so that it can rapidly calculate Similarity Scores and Output Values.

When the dataset is too large for the Cache and RAM, some of it must be stored on the Hard Drive. Since reading and writing data to a hard drive is slow, the algorithm tries to minimize these actions by compressing the data. The procedure is called Block for Out-of-Core Computation. Even if the CPU must spend time decompressing the data that comes from the Hard Drive, it can do it faster than the Hard Drive can read the data. Moreover, when there is more than one Hard Drive attached to the machine, the algorithm uses a database technique called Sharding to speed up the disk access. Then, when the CPU needs data, both drives can be reading data at the same time.

Moreover, the algorithm can speed up building trees by only looking at a random subset of features when deciding how to split the data.

The trained network used for building the hierarchical classifier is the skip-gram network with n-grams word embeddings.

### Dataset

In natural language processing, as far as tasks are concerned (Classification, Machine translation, CBOW, Skip-gram, Natural Language Understating, etc.), the model is trained based on a dataset. The dataset is a collection of texts called Corpus in literature (body in Latin). This can be composed of groups of texts written in a single language or in multiple languages. There are various reasons for having multilingual Corpora (plural for Corpus), especially in text understanding and machine translation, where the correlation between words in multiple languages and their correlated synonyms should be well determined. For example, in English, the words ‘same’ and ‘equal’ are synonyms but translated into another language, they can result in different words.

The dataset highly influences the model's performance. For example, themed texts, like historical or modern (making use of neologisms), can affect the model's accuracy and text understanding results when used for classifying regular vocabulary.

There is no language in which the domains have a meaning. Even if many of them are based on a name or words from vocabulary like ‘example.com’, there are many randomly generated domains like ‘asfgfdewgfdsagtersdd.com’. Another example, the word ‘google’ was not in any vocabulary until recently, proving that domain names do not always have a meaning.

For those reasons, the corpus is composed exclusively of domains. The main task of the neural network, such as the Embedding Network, is to understand the correlation between words in the corpus and calculate the probability, such as contextual probability, of words and contexts in a sentence. Since domains don't have a meaning in most languages, a multilingual corpus would not be helpful.

This is a unique element in NLP and in cybersecurity, to train a neural network on an invented “language”, the language of the domains, and to train the network to understand this language.

The corpus dataset is composed of 50 million domains. They are all labeled domains, but that is not relevant for this neural network, such as the Embedding Network, since it was trained unsupervised.

On the contrary, when combining the tree-based classifier, such as the Domain Risk Classifier, with the natural language processing network, such as the Embedding Network, the labelled training dataset was composed of 6 million domains.
1. 3 million->clean (benign) domains discovered by Heimdal Security through a ranking system. Most of them were highly used domains.
2. 3 million->malicious (malign) and active domains. There is a big challenge to find malicious domains still active. The mean lifespan of an infected website is seven days. After this period, most of the zero-day websites are taken down. For this reason, it was a real challenge to find this number of active hostile websites. Moreover, all of the infected domains had to be labeled and used so that the dataset is balanced. The categories from the malicious dataset are: “Command and Control”, “Phishing”, “Typo squatting”, and “General Malware”.

### Natural Language Processing Model

The model is derived from the continuous skip-gram model introduced by Mikolov et al (Tomas Mikolov, 2013). It will be appreciated that computers cannot understand words, but they can understand numbers. Therefore, vectorial representations of those words are necessary. Each word will be represented by a vector whose values will be adjusted during the training.

As a non-limiting example for illustration purposes, consider a toy vocabulary: computer, engineer, house, dog, horse. After training (numbers shown for illustration), the model might learn 3-dimensional embeddings such as:

$$computer \to [ 0.82 , - 0.1 , 0.45 ]$$

$$house \to [ 0.79 , - 0.05 , 0.41 ]$$

$$engineer \to [ - 0.3 , 0.9 , - 0.12 ]$$

$$dog \to [ 0.1 , 0.15 , 0.88 ]$$

$$horse \to [ 0.12 , 0.2 , 0.85 ]$$

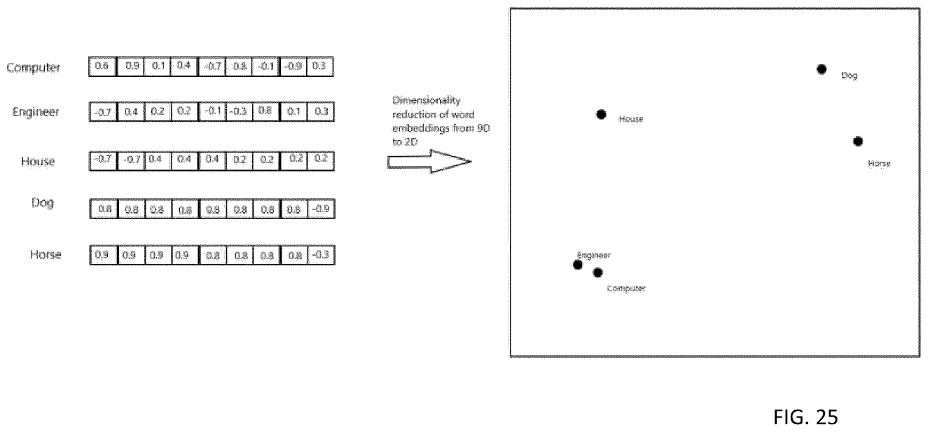

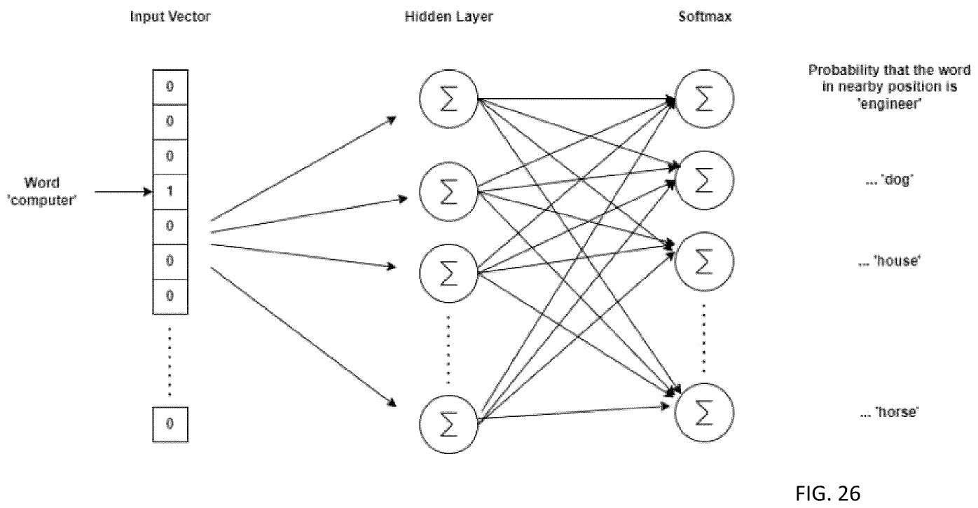

By the end of the training process, the word vectors should rearrange their values so that similar words will be close to each other in the multidimensional space, as shown in FIG. 25.

The phrases in the corpus determine the correlation between words. If the corpus contains phrases in which the words “computer” and “horse” are mutually related, the embeddings will be close together in the multidimensional space. Hence the importance of a variate corpus, considering that the model will be as accurate as the dataset.

In practice, the computer engineers will use all the text in the training language, from Wikipedia, books, science articles, movie subtitles, emails, etc.

Since the model contains the domain's language, there will be no correlation between words, so the model should be adapted to subwords.

The original training algorithm proposed by Mikolov et al. for word embeddings fulfills two purposes, CBOW and Skip-Gram. Starting from a dataset of sentences, the algorithm chooses each word in the sentences and tries to predict its neighbors, also called the contexts. (Skip-gram). On the other hand, those contexts can be used to predict the current word (CBOW). The task needed for domains classification is Skip-gram since it is desired to determine variations of domains starting from a base. (google.com->goooogle.com->googleads.com->google.dk, etc.)

The model architecture is composed of one or multiple hidden layers trained to perform a task with a SoftMax head. The network is not used for the trained task, and its only goal is to learn the weights in the hidden layers. The main advantage of this type of architecture is the unsupervised learning method because a supervised learning method would imply labeling the whole dataset. A labeling system would require a human to read and input the correlation between words in all the existing text in a language. That task would be close to impossible.

There is no dimensionality reduction layer during the training process. Since the input vector is formed by the number of words in the dictionary (50 million rows in the present corpus), each word will have a number of features (number of neurons in the hidden layers, 300). The output vector is the same size as the input, and each word in the input will get an assigned probability in the output.

At the end of the training process, only the hidden layer weight matrix is kept and used as word embeddings. The output layer is a SoftMax regression classifier that is no longer useful after the training.

Since the dataset is composed only of domains and no sentences, the algorithm proposed initially by Mikolov et al. (Tomas Mikolov, 2013) cannot perform well. For this reason, an approach close to Mikolov in (Piotr Bojanowski, 2017) at Facebook AI Research is better suited.

Bojanowski et al. (Piotr Bojanowski, 2017) proposed a model that, given a word vocabulary of size W, will learn a vectorial representation for each w∈{1, . . . , W} by maximizing a log-likelihood function between words and contexts (words surrounding w).

$${\sum }_{t = 1}^{T} {\sum }_{c ∈ {𝒞}_{t}} log p ( {w}_{c} \vert {w}_{t} )$$

The previously described model determines the probability of a context word using a SoftMax function.

$$p ( {w}_{c} \vert {w}_{t} ) = \frac{{e}^{s ( {w}_{t} , {w}_{c} )}}{{\sum }_{j = 1}^{W} {e}^{s ( {w}_{t} , j )}}$$

Since multiple context words cannot be predicted from the center word (the dataset is composed only of domains), the model should be adapted to a different task as in Markov et al. 2017 (Piotr Bojanowski, 2017) using a binary logistic loss obtained from the negative log-likelihood.

$${\sum }_{t = 1}^{T} [ {\sum }_{c ∈ {𝒞}_{t}} ℓ ( s ( {w}_{t} , {w}_{c} ) ) + {\sum }_{n ∈ {𝒩}_{t , a}} ℓ ( - s ( {w}_{i} , n ) ) ]$$

The most important feature of this network is the sub word model, a separate word representation that also considers the internal structure of words. Domains are words with multiple variations from a legit domain like google.com. An attacker can register a lookalike domain like googgle.com. This type of attack is called typosquatting, in which an attacker uses a spelling error to mislead the user into thinking that he is on a legit website. The most spread typosquatting is the dot extraction. A domain like ‘www.example.com’ can be reproduced as ‘wwwexample.com’, and that missing dot can trick the user into arriving on a phishing website. Usually, the big companies buy all the correlated domains of their websites, but there are too many variations most of the time.

Each word is represented by a bag or a set of character n-grams summed with the word itself. For a word w, Gw⊂{1, . . . , G} is the set of n-grams of w. The scoring function will become:

$$s ( w , c ) = {\sum }_{g ∈ {𝒢}_{w}} {z}_{g}^{T} {v}_{c}$$

### Natural Language Processing Model Prediction and Performance

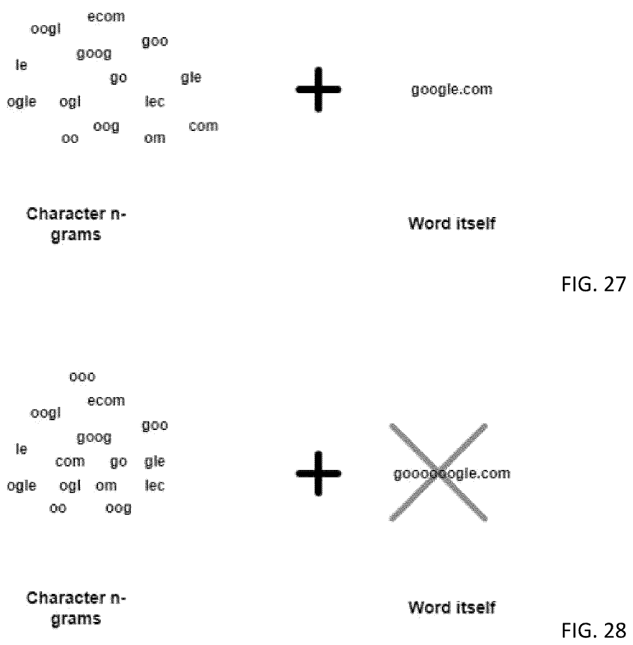

Using character-level n-grams, the model will exploit the sub-word information, thereby increasing accuracy. In this way, vectorial representations can be built for unseen words, like domains. FIG. 27 shows an example of word embeddings creation during the model training period using the domain “google.com” from the corpus.

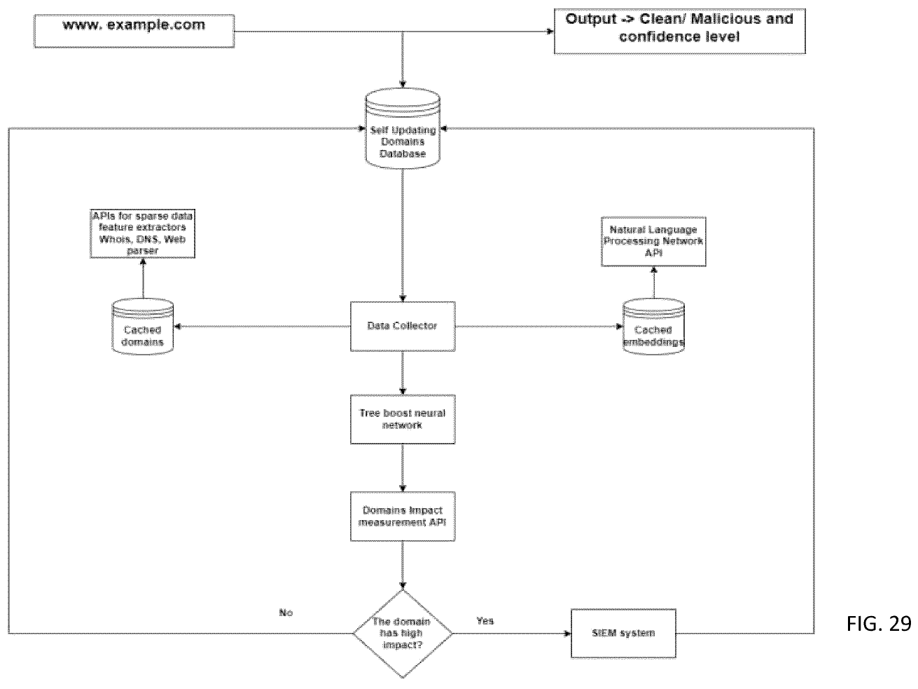

At the inference (literature word for applying knowledge from a trained network to determine a new result, different from the training set) level, when the model should extract the embeddings for a newly generated domain like ‘goooooogle.com’, since the domain is a zero-day not in the corpus, the final word vector will be composed of the sum of n-grams. See FIG. 28.

With solid and proper trained embeddings, the domains “google.com” and “goooooogle.com” need not be close in the embedding space. Because repetition and obfuscation patterns alter the n-gram composition and context statistics, the learned embeddings place such variants farther apart, enabling the downstream classifier to distinguish benign domains from repetition-based typo squats.

The accuracy of the embeddings can be measured, both during training and after, using standard intrinsic and extrinsic metrics. The validation loss of the training objective guides model selection and early stopping.

Even so, the robustness of the embeddings can be measured by calculating the distance between similar domains in the feature space. Multiple algorithms can calculate the distance between vectors in a multi-dimensional space, like Euclidian distance, Cosine Similarity, Manhattan distance, Soft Cosine Similarity, Dot Product, etc. The implementation pipeline used Cosine Similarity to measure the distance between word vectors.

$$cosine similarity = {S}_{C} ( A , B ) := cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt[2]{{\sum }_{i = 1}^{n} {B}_{i}^{2}}} ,$$

After the training period, the similarity of multiple domains was measured, where some of them were already in the dataset and some of them were randomly generated. A part of the results can be seen in the following table. It describes the top 10 correlated domains in the feature spaces based on the input using cosine similarity.

Input Domain

| Output | google.com | fdnmgkfd.com |
|---|---|---|
| 1 | googlec.com | fdsfd.com |
| 2 | google-adware.com | fdgfd.com |
| 3 | gooogle.com | fd4d.com |
| 4 | goooogle.com | fdd.com |
| 5 | googletune.com | fd7qz88ckd.com |
| 6 | google-sale.com | fdsyd.com |
| 7 | googlewale.com | fdg-ltd.com |
| 8 | googledrie.com | fdrs-ltd.com |
| 9 | goooooogle.com | fcbd.com |
| 10 | goolge.com | fcb88d.com |

The domain ‘google.com’ in the table above was in the original dataset. When used in prediction, the results show that the network was able to learn and is not underfitted since the results are similar.

The second domain in the table above is a random number of characters with the top-level domain ‘.com’. Those types of domains are used in C&C attacks. The results show that the network is not overfitted, and it generalizes well on data never seen in the dataset.

Based on that information, the embeddings are strong enough to be used in a classifier, such as the Domain Risk Classifier. The resulting embeddings will be concatenated with sparse data features and used in the tree boost classifier, such as the Domain Risk Classifier, previously described.

The invention uses two very powerful trained networks (the Embedding Network and the Domain Risk Classifier), to analyze, interpret and understand zero-day threats (threats that are so new/recent that cybersecurity vendors are not aware of them).

The invention achieves synergies from data engineering, machine learning, and research. It is a complex suite of multiple algorithms and programming techniques described in the following chart. The diagram flow in FIG. 29 shows the process of classifying a domain using the described software for predicting malicious domains.

### Huffman-Coded Hierarchical Classifier

As one of ordinary skill in the art will appreciate, a standard softmax function converts a vector of raw scores (logits) into a probability distribution over multiple possible outcomes, ensuring that each probability is between 0 and 1 and that all probabilities sum to 1. When a model must choose among n number of possible context words, evaluating n number of independent softmax logits is expensive. An elegant workaround is hierarchical softmax.

Hierarchical softmax is a computational technique that replaces the standard softmax function with a binary tree structure to significantly speed up training and prediction for models with large vocabularies. Instead of calculating probabilities for every word, hierarchical softmax computes the probability of a target word by traversing the tree from the root to the word's leaf node, multiplying the probabilities at each internal node along the path. In the context of the present invention, hierarchical softmax involves building a binary tree having leaf nodes that correspond one-to-one with the words in the vocabulary. Each internal node stores a single binary logistic regressor. A word's probability is the product of the logistic outputs along the unique root-to-leaf path leading to that word.

As will be appreciated by one of ordinary skill in the art, Huffman coding is a lossless data compression algorithm that assigns variable-length codes to input characters based on their frequencies. Characters that appear more frequently in the data are assigned shorter binary codes, while less frequent characters receive longer codes. This minimizes the overall number of bits required to represent the data. A Huffman coding algorithm is applied to corpus frequency counts to assign each context word a variable-length binary code. The resulting codebook is arranged as a binary tree referred to as a Huffman tree.

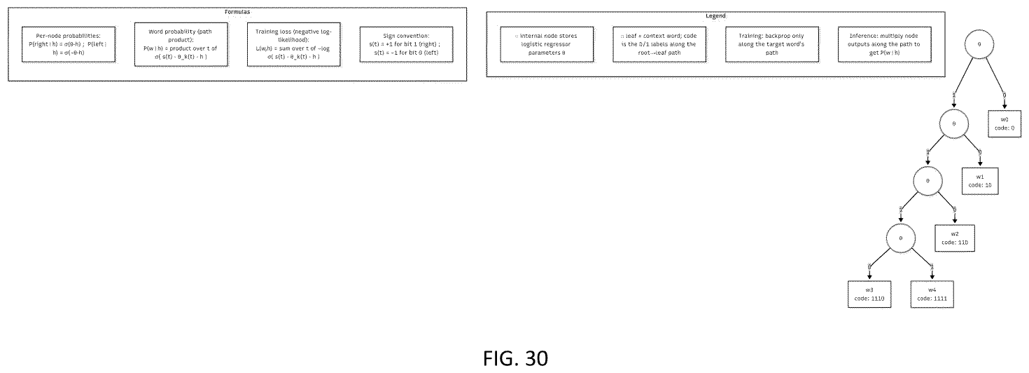

A Huffman tree is a binary tree having leaf nodes that represent the characters and their frequencies, and internal nodes that represent the sum of frequencies of their child nodes. In the context of the present invention, the leaf nodes of the Huffman tree store the context words (n-grams) and the internal nodes store the parameters of a hierarchical softmax classifier. FIG. 30 shows the binary Huffman tree with example codes beside each leaf. The path from the root to a leaf node defines the character's code. During training, the gradient for a target word is back-propagated along the corresponding root-to-leaf Huffman path, updating only the internal nodes on that path.

The Huffman tree can be arranged in many ways. A classic approach is to run the Huffman algorithm on word-frequency counts (Mikolov et al., 2013). Because a Huffman algorithm assigns shorter binary codes to frequent symbols, high-frequency words end up near the root, and therefore require fewer logistic evaluations at training/inference time. Each leaf node represents a context-word code generated by the Huffman tree algorithm.

It will be appreciated that a Huffman tree is not the same as a decision tree. A decision tree leaf contains the final class label or regression value, wherein the path is chosen by deterministic splits on feature values. In contrast, a Huffman/hierarchical-softmax tree leaf contains a word, and the path is traversed every time, with each internal node producing a probabilistic output that participates in the final likelihood. The Huffman tree structure is not learned from features; it is fixed by the Huffman codebook.

In some embodiments, the Huffman tree is constructed once from corpus token (n-grams) frequencies and then held fixed during training. Each leaf corresponds one-to-one with a context word (token or n-gram) and stores the word identifier and its binary code. Each internal node stores the parameters of a binary logistic regressor (weights θ and, optionally, bias b). Edges are labeled with bits, with the convention left=0 and right=1; the concatenation of edge labels on the unique root-to-leaf path equals the word's Huffman code. For a training example with hidden vector h (computed from the center token), the per-node probability of taking the right branch at internal node k is σ(θₖ·h+bₖ) and the probability of taking the left branch is σ(−(θₖ·h+bₖ)). The probability of a target context word w is the product of these node probabilities along its path:

$$P ( w \vert h ) = {\prod }_{i = 1}^{L ( w )} σ ( {s}_{i} ( {θ}_{{k}_{i}} \cdot h + {b}_{{k}_{i}} ) ) ,$$

$${s}_{t} ∈ \{ + 1 , - 1 \} with {s}_{i} = + 1 for bit 1 ( right ) , {s}_{t} = - 1 for bit 0 ( left ) .$$

Training minimizes the negative log-likelihood −log P(w|h) and updates only the internal nodes on that path (together with the parameters that produced h). Inference traverses the same path to compute P(w|h). The tree code assignments are frequency-optimal in the Huffman sense; ties in frequency are broken deterministically (e.g., lexicographic on token ID) to yield a unique codebook. This embodiment reduces per-example compute from O(V) (full softmax over vocabulary size V) to O(L(w)), with expected cost bounded by the average code length E[L]<=H(p)+1, where H(p) is the entropy of the token distribution.

In some embodiments, the method further comprises using a Bayesian probability system for determining a risk score of a domain. In other words, the method may further comprise combining the probability output of the Domain Risk Classifier with a Bayesian updater to produce a posterior risk score for the domain. Let:
π—prior probability a domain is malicious (optionally conditioned on TLD/ASN/etc.).
p_{model}—probability output by the Domain Risk Classifier.
πₜᵣₐᵢₙ—class prior used when training/calibrating the Domain Risk Classifier (if known).
eᵢ—additional evidence signal;
   Work in odds form. Define:

### Odds Definitions

$${O}_{prior} = \frac{π}{1 - π}$$

$${O}_{model} = \{ \begin{matrix}\frac{{p}_{model}}{1 - {p}_{model}} \cdot \frac{1 - {π}_{train}}{{π}_{train}} , & if {π}_{train} known \\ \frac{{p}_{model}}{1 - {p}_{model}} , & otherwise\end{matrix}$$

### Posterior (Odds and Probability)

$${O}_{post} = {O}_{prior} \cdot {O}_{model} \cdot {\prod }_{i} {Λ}_{i}$$

$${P}_{post} = \frac{{O}_{post}}{1 + {O}_{post}}$$

The posterior risk score Pₚₒₛₜ is reported as the final domain risk. The method may further comprise incremental updates where, as new evidence arrives after the model score is computed, the updater multiplies the current odds by the new likelihood ratio and renormalizes:

$${ℓ}_{post} = {\underbrace{log \frac{π}{1 - π}}}_{prior lo g - odds} + {\underbrace{log \frac{{p}_{model}}{1 - {p}_{model}}}}_{model logit} - log \frac{π}{1 - {π}_{train}} + {\sum }_{i} log {Λ}_{i} ⇒ {P}_{post} = σ ( {ℓ}_{post} )$$

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A computerized method for calculating the probability of a domain being malicious based on an input dataset, the method comprising:
data extracting, including extracting from the input dataset at least two types of input data comprising:
network data comprising one or more of WHOIS data, DNS data, Reverse PTR data, Domain Ranking data and popularity data, and Domain Authority data; and
Domain Word data in a corpus;
data preprocessing, including transforming the network data from sparse to dense network data;
data preprocessing, including transforming the Domain Word data into vectorial representations using a trained Embedding Network;
data preprocessing, including constructing feature vectors by concatenating the vectorial representations with the dense network data; and
processing the feature vectors through a trained Domain Risk Classifier to determine a probability of the domain being malicious,
wherein the Embedding Network is a natural language processing network trained on the Domain Word data in the corpus using a hierarchical classifier implemented as a binary tree and constructed by executing a Huffman coding algorithm; and
wherein the Domain Risk Classifier is a gradient-boosting classification tree trained on a labeled training dataset.

2. The method according to claim 1 wherein the Embeddings Network that transforms the Domain Word data into vectorial representations is trained unsupervised, using a natural language model to predict a target context based on a nearby center word.

3. The method according to claim 2 wherein the data preprocessing step for transforming the Domain Word data into vectorial representations further comprises:
data preprocessing for representing words as vectors using n-grams; and
data preprocessing for filling in missing data, such as for out-of-vocabulary n-grams or missing tokens, using a designated mask/unknown embedding or computing a fallback embedding by composing the available subword n-grams.

4. The method according to claim 1 wherein a data processing algorithm of the Domain Risk Classifier uses similarity scores, gains, and thresholds for determining a probability.

5. The method according to claim 1 wherein the Domain Risk Classifier uses a probability distribution over classes (malicious, benign) to determine a risk factor.

6. The method according to claim 1 further comprising combining the classifier probability with a Bayesian probability system to produce a posterior risk score for the domain.

7. The method according to claim 1 executed within a cybersecurity risk-assessment pipeline configured for domain risk scoring.

8. The method according to claim 1 including a process for reading data in batches for optimizing the computer resources through which the method is implemented.

9. The method according to claim 1 including a process for minimizing memory consumption by splitting data reading and data processing in CPU, RAM, Cache and HD memory.

10. The method according to claim 1 further comprising parallel learning and inference based on splitting data in quantiles.

11. The method according to claim 1 further comprising implementing a machine learning pipeline adapted to generate random trees and calculate a gain and similarity score for each random tree based on a threshold, and calculate an output value and adjust weights based on an error rate (loss function), and calculate a needed adjustment for improving accuracy based on a test dataset through a second-order Taylor approximation between the error rate (loss function), a gradient (first derivative of the loss function), and a hessian (second derivative of the loss function).

12. The method according to claim 1 wherein the Embedding Network comprises a trained neural network.
